(19) United States
(12) Patent Application Publication
(10) Pub. No.: US 2015/0091479 A1
(43) Pub. Date: Apr. 2, 2015

(54) Electric Vehicle Propulsion System Using Magnetic Piston Engine

(71) Applicant: Jonathan David L. Spivak, North York (CA)

(72) Inventor: Jonathan David L. Spivak, North York (CA)

(21) Appl. No.: 14/042,843

(22) Filed: Oct. 1, 2013

(51) Int. Cl. H02K 33/12; B60L 11/12

(52) U.S. Cl. CPC H02K 33/12; B60L 11/12; Y10S 74/09; H02K 53/00
USPC 318/139; 74/DIG. 9

(57) ABSTRACT

An electrical vehicle propulsion system having dual electric magnetic piston engines is disclosed. The first magnetic piston engine is used to provide propulsive force to the vehicle while the second magnetic piston engine is used to drive a DC electric generator. The first and second electric piston engines are driven by current from a series of rechargeable batteries which are at least partially recharged by the DC electric generator. The recharging of the batteries being done via a battery controller which is configured to recharge the batteries cyclically such that while some batteries are drained to provide current for the electric magnetic piston engines, other batteries are recharged.

### FIELD OF THE INVENTION

The invention relates generally to electric vehicles using electric engines of the type having a reciprocating magnetic piston.

### BACKGROUND OF THE INVENTION

The present standard design for an electric car is for the batteries to spin a direct current (DC) motor, which is used to power the car; the batteries are recharged from an external source of electricity. Presently, there is an array of charging technology vying for dominance but the sure winner will be the fast DC charging system. However, the one drawback to the current electric car market is that public has an aversion towards these cars due to range anxiety. That is fear that the batteries will be totally drained before the driver reaches his/her destination.

Electric motors usually consist of a stator and a rotor, with both the stator and the rotor consisting of electromagnets. In some high performance compact electric motors, the stator (or sometimes the rotor) may incorporate permanent magnets. While this arrangement is tried and true, it does have some drawbacks. An alternative approach is to use a reciprocating magnet, much like a piston, which is forced back and forth within a coil (i.e. a solenoid), whose polarity changes cyclically so as to drive the piston in both directions. An improved system that does not require a change in polarity of the electromagnets would be advantageous in the application of electric vehicle engines and in extending the range of these vehicles.

### SUMMARY OF THE INVENTION

In accordance with one aspect of the present invention, there is provided an electric vehicle propulsion system which utilizes two electric engines, namely a first magnetic piston engine for providing propulsive force to the electric vehicle and a second magnetic piston engine for driving a DC electric generator. The vehicle also has rechargeable batteries for providing electric power to the first and second magnetic piston engines, the rechargeable batteries being coupled to the DC electric generator to be at least partially recharged by the DC electric generator. Each of the first and second magnetic piston engines each include a magnetic piston having opposite first and second ends with a north and south magnetic polls formed on said first and second ends. The magnetic piston is slidingly received in an elongated passage formed in a housing, the elongated passage having opposite first and second ends. The elongated housing configured to permit the magnetic piston to reciprocate between first and second positions corresponding to the first and second ends of the elongated passage, respectively. The magnetic piston is oriented in the passage such that the first end of the magnetic piston is oriented towards the first end of the passage and the second end of the magnetic piston is oriented towards the second end of the passage. A first electromagnet is positioned in the housing immediately adjacent the first end of the passage, the electromagnet configured to generate a north magnetic pole oriented towards the first end of the passage when the first electromagnet is activated. A second electromagnet is positioned in the housing immediately adjacent the second end of the passage, the electromagnet configured to generate a south magnetic pole oriented towards the second end of the passage when the second electromagnet is activated. There is also provided an electric current source for providing an electric current sufficient to activate the first and second electromagnets. First and second switches are coupled between the electric current source and the first and second electromagnets, respectively, the first and second switches being mounted to the housing adjacent the first and second ends of the passage such that the first and second switches contact the magnetic piston when the magnetic piston is in its first and second position, respectively. Each of the first and second switches are configured to close only upon contact with the magnetic piston, the first and second switches immediately opening when the magnetic piston is no longer in contact.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a schematic view of an electric engine made in accordance with the present invention.

FIG. 2 is a schematic view of an electric vehicle propulsion system engine made in accordance with the present invention.

FIG. 3 is a schematic view of the electric engine shown in FIG. 1 with the magnetic piston in a first position.

FIG. 4 is a schematic view of the electric engine shown in FIG. 1 with the magnetic piston in a second position.

In the drawings like characters of reference indicate corresponding parts in the different figures.

### DETAILED DESCRIPTION OF THE INVENTION

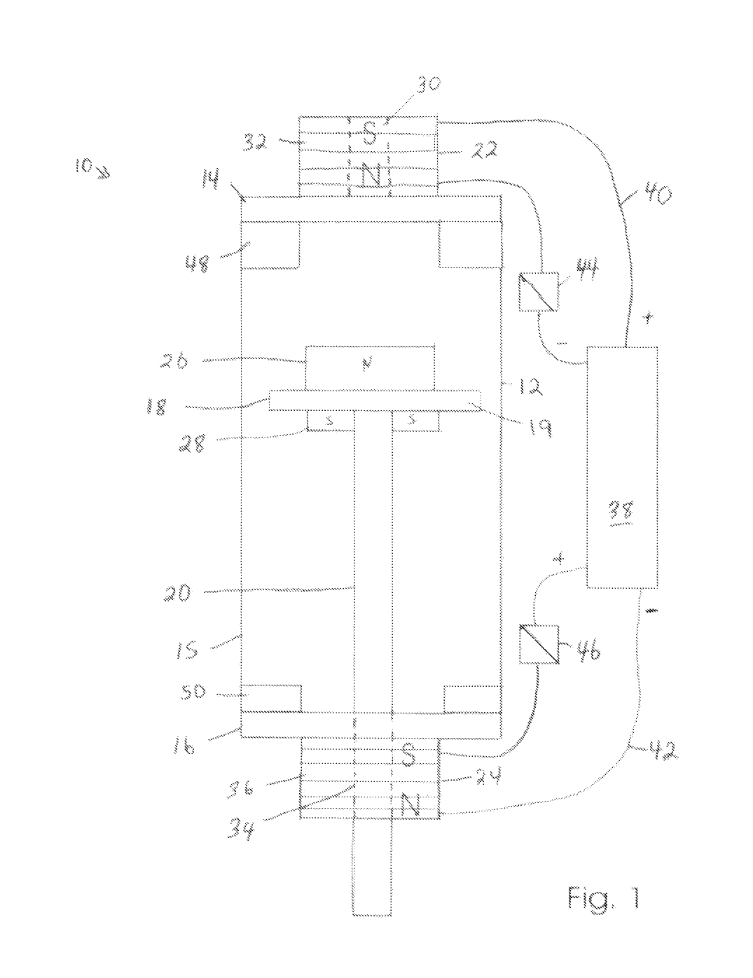

Referring to FIGS. 1, an electric engine made in accordance with the present invention is shown generally as item 10 and consists of a housing 12 having an elongated passage 15 having opposite first end 14 and second end 16. Positioned within passage 15 is a magnetic piston 18. Housing 12, passage 15 and magnetic piston 18 are configured much like a piston in a cylinder as would be found in an internal combustion engine or piston pump. Magnetic piston 18 is free to move back and forth between ends 14 and 16 in a reciprocating fashion, again much like a piston in a cylinder. A piston rod 20 (made from non-magnetic metal) is coupled to magnetic piston 18 and is used to couple the magnetic piston to an external device such as a crank shaft or flywheel (not shown). First and second electromagnets 22 and 24, respectively, are positioned at opposite ends 14 and 16 of housing 12. Magnetic piston 18 is rendered magnetic by means of first and second permanent magnets 26 and 28, respectively, mounted to non-magnetic (i.e. nonferrous) plate 19. Magnetic piston 18 consists of a non-ferrous metal plate 19 mounted to permanent magnets 26 and 28. Magnet 28 is torus shaped to accommodate piston rod 20 and magnet 26 is cylindrical and dimensioned to fit within pad 48. Magnets 26 and 28 are oriented such that a north (N) magnetic pole is oriented towards end 14 and a south (S) magnetic pole is oriented towards end 16. Electromagnet 22 is configured such that when it's activated, it generates a north magnetic pole oriented towards magnetic piston 18. Electromagnet 24 is configures such that when it's activated, it generates a south magnetic pole oriented towards magnetic piston 18.

Side walls 15 of housing 12 should not be made of any ferrous (or magnetic) metal; however, ends 14 and 16 should be made of a ferrous (i.e. magnetic) metal. Preferably, housing 12 consists of a cylinder whose walls 15 are made of a non-magnetic material such as aluminum or a non-magnetic steel alloy and ends 14 and 16 are formed as flat plates of a magnetic metal such as ferromagnetic steel. Electromagnet 22 preferably consists of a solid cylindrical bar 30 made out of a magnetic material which is coupled to end 14 by means known generally in the art. An electrical winding 32 is formed onto solid bar 30 to form an electromagnet. Similarly, electromagnet 24 is made from a hollow cylindrical member 34 made of a magnetic material (such as iron) upon which a winding 36 is formed. Cylindrical member 34 is mounted to plate 16 by means known generally in the art. Plate 16 has an aperture dimensioned to permit piston rod 20 to pass there through. Cylindrical member 34 is dimensioned to permit piston rod 20 to pass there through and the hollow cylinder and the plate are coaxially aligned.

Electromagnets 22 and 24 are electrically coupled to current source 38 by means of electrical circuits 40 and 42, respectively. Interposed in circuits 40 and 42 are electrical switches 44 and 46, positioned adjacent ends 14 and 16, respectively. Switches 44 and 46 are biased towards an open state and close only when magnetic piston 18 is immediately adjacent the switch. Switches 44 and 46 may consist of any highly reliable and fast switch such as an optical switch, a micro-switch or even bare contacts. When magnetic piston 18 is immediately adjacent or in contact with switch 44, the switch is placed in its closed configuration, thereby completing circuit 40 and activating electromagnet 22. When magnetic piston 18 is immediately adjacent or in contact with switch 46, the switch is placed in its closed configuration, thereby completing circuit 42 and activating electromagnet 24. When magnetic piston is interposed between switches 44 and 46, as shown in FIG. 1, both switches 44 and 46 are in their open position, thereby ensuring that neither electromagnet 22 or 24 are activated.

As mentioned above, switches 44 and 46 are electric switches which are biased towards an open state. Nearly any suitable electrical switching device can be used to form switches 44 and 46. Switch 44 is configured to close when magnetic piston 18 is positioned as close to plate 14 as possible, preferably with magnet 26 either touching or very nearly touching plate 14. First pad 48 can be provided immediately adjacent plate 14. Pad 48 can be made shock dampening and can be coupled to switch 44 such that when plate 19 touches pad 48, switch 44 is placed into its closed state. For such an arrangement, pad 48 may form electrical contacts which, when contacting magnetic piston 18, cause switch 44 to close. Likewise, switch 46 may consist of a relay like device coupled to second pad 50 such that when pad 50 contacts magnetic piston 18, switch 46 is placed in the closed position and electromagnet 24 is activated. Alternatively, switches 44 and 46 may consist of relays which are coupled to optical sensors located adjacent the end of housing 10 which are triggered not by physical contact with the magnetic piston, but rather by the proximity of the magnetic piston to the optical sensors.

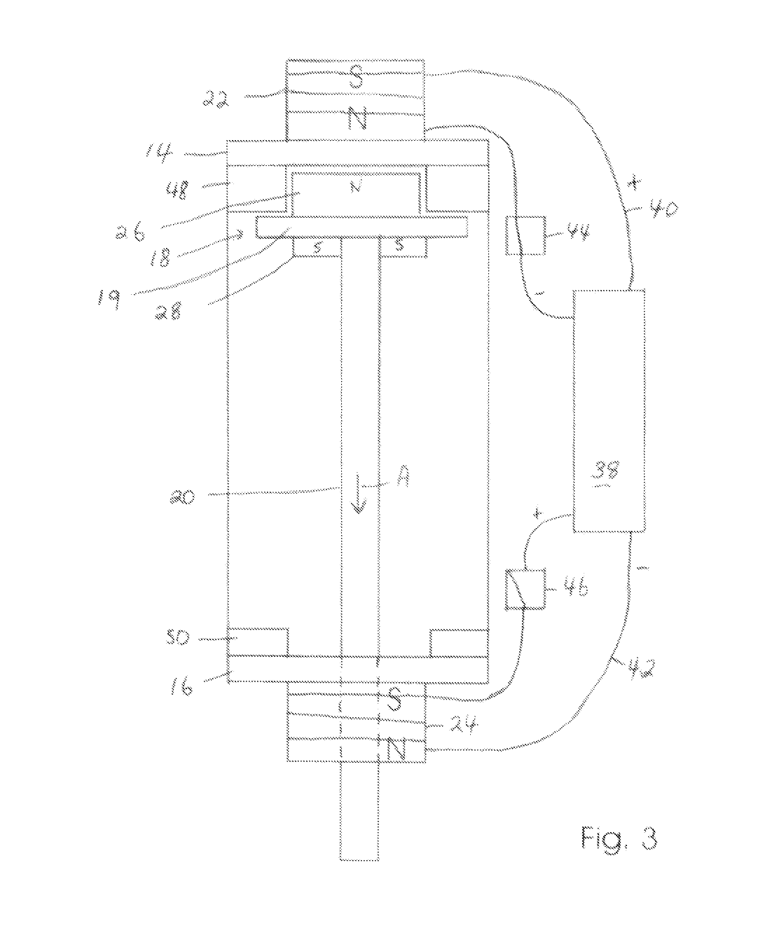

Referring now to FIG. 3, when plate 19 touches pad 48, switch 44 is closed and electromagnet 22 is activated. Since permanent magnet 26 is oriented with its N magnetic pole oriented towards electromagnet 22, and since electromagnet 22 is configured to generate a N magnetic pole oriented towards the magnetic piston, there is a strong repulsive force applied to the magnetic piston forcing the magnetic piston away from plate 14. This force is applied to piston rod 20 in the direction indicated by arrow A. Pad 48 is annular in shape and magnet 26 is configured to fit within pad 48. This ensures close contact between plate 14 and magnet 26 thereby increasing efficiency. Switch 44 is configured to keep the circuit closed for a sufficient interval of time required to ensure the magnetic piston moves away from plate 14 and away from pad 48. Piston 18 then moves away from end (plate) 14 and towards plate 16 by the action of momentum.

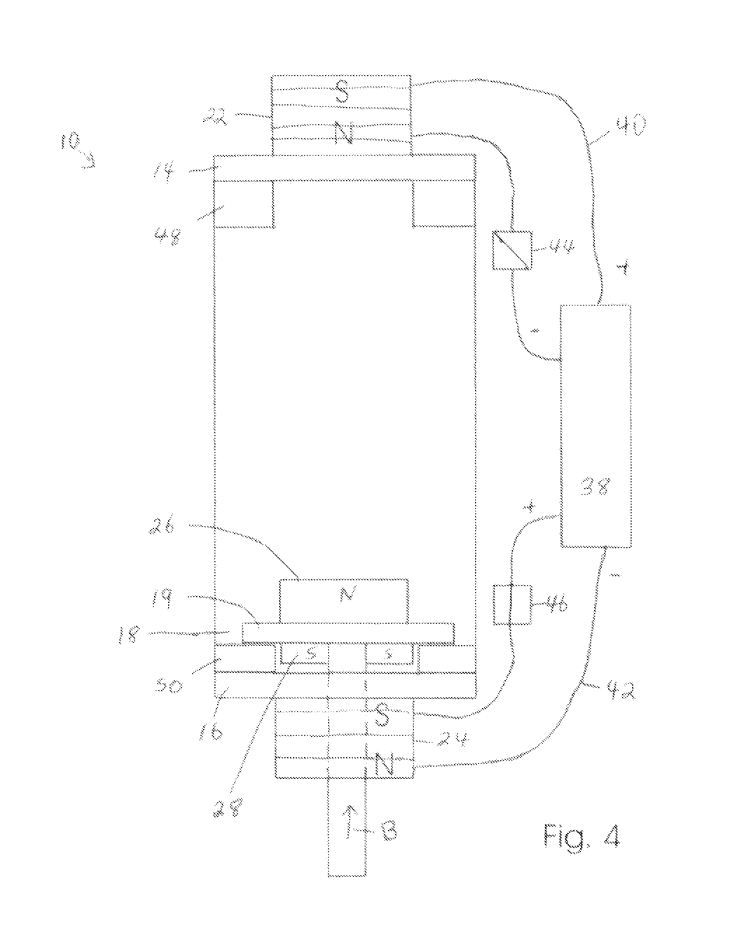

Referring now to FIG. 4, when plate 19 touches pad 50, switch 46 is closed and electromagnet 24 is activated. Pad 50 is also annular and magnet 28 is configured to fit within the annulus of pad 50 in order to be in as close a physical proximity to plate 16 as possible. When electromagnet 24 is activated, a S magnetic pole is generated by electromagnet 24 which is oriented towards magnetic piston 18. Magnet 28 has its S magnetic pole oriented towards electromagnet 24, so there is a strong repulsive force applied to the magnetic piston in the direction indicated by arrow B. This in turn forces piston 18 away from electromagnet 24 and towards electromagnet 22. In this way, switches 44 and 46 cyclically open and close forcing the magnetic piston to rapidly reciprocated between ends 14 and 16.

It will be appreciated that electromagnets 22 and 24 always maintain the same polarity and at no time does the polarity of the electromagnets switch. It will also be appreciated that the reciprocating back and forth movement of the magnetic piston can be translated into a rotational movement by means of a crank shaft, as is well known in the art. A multi-cylinder electric motor can be created by linking together several separate cylinder/piston arrangements via a common crank shaft. In such a multi-cylinder magnetic piston motor, the cylinders can be arranged in opposition, vertical or they may be arranged in a V configuration.

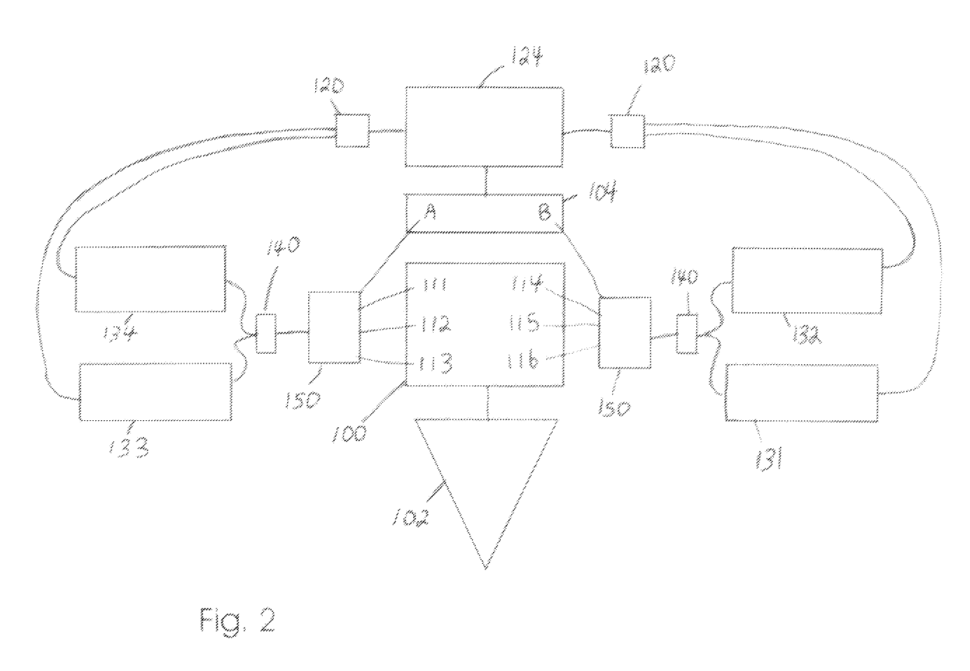

Referring now to FIG. 2, the electric piston engine of the present invention is particularly useful for use in a plug-in electric car engine. FIG. 2 illustrates an example of how to achieve limited use of self-charging a second set of batteries that are off-line. In this diagram an electric vehicle (not shown) incorporates a plurality of electric pistons engines made in accordance with the present invention in multi-piston arrangement with a first six piston engine 100 used for powering the transmission 102 and a second two piston engine 104 be used to spin a DC electric generator 124. The six pistons used for powering the transmission 102 are numbered 111 through 116. The two pistons used to spin the DC electric generator 124 are numbered as A and B. Once again, the pistons powering the transmission 102 are on a common crankshaft that is separate from the single or multiple pistons used to spin the DC electric generator 124.

Regarding the type of engine configurations that will work with the preferred engine design is the “straight” or also called inline engine, the “flat” or also called horizontally opposed engine and the V-engine, although different combinations of pistons can be selected. You can have a single piston or multiple pistons but if an odd numbers of pistons are being employed, only the straight/inline and V-engines can accommodate this configuration. It is not necessary that the two separate crankshafts be using the same engine configuration; for example the pistons spinning the DC electric generator could be set up using the flat engine design, while the pistons powering the transmission could be using the V-engine design. Deciding on the total number of pistons to employ needs to be based on the trade-off between engine power versus generating sufficient electricity to recharge the batteries that are off-line.

In the system illustrated in FIG. 2 there are four batteries; two are always on-line while two are off-line. The primary electronic switches 120 on either side of the DC electric generator 124 can only send the electrical current to one battery at a time. When the electrical current from the generator is sent to a battery that battery is off-line, meaning it is being recharged. While the battery that is not receiving the electrical current from the primary electronic switch is on-line, meaning it is supplying its electricity to the electromagnetic pistons. When batteries 131 and 133 are on-line, the primary electronic switches 120 will shut off the electric current from the DC electric generator 124 to these batteries, while allowing the electric current to flow towards batteries 132 and 134. When this happens, the secondary electronic switches 140 will cut off the electrical currents of batteries 132 and 134 from entering the step-up transformers 150, thus batteries 132 and 134 will be in recharge mode. Meanwhile, for batteries 131 and 133, electrical currents will be allowed to proceed through the step-up transformers 150 in order to increase the voltage heading towards the electromagnetic pistons. When either batteries 131 or 132 are on-line, their electrical current will go to electromagnetic pistons 114, 115, 116 and B. When either batteries 133 or 134 are on-line their electric current will go to electromagnetic pistons 111, 112, 113 and A.

Once batteries 132 and 134 are recharged sufficiently (do not require them to be 100% recharged) then the process is reversed. The car's software can be programmed to reverse the recharging system for instance based on the on-line battery's depletion percentage. There are various methods that the car manufacturer can set the reversal of this internal recharging system. In the reversal process, the primary electronic switches 120 allow the current from the DC electric generator 124 to flow to batteries 131 and 133, while the secondary electronic switches 140 will cut off the electrical currents from batteries 131 and 133 from entering the step-up transformers 150, thus batteries 131 and 133 will be in recharge mode. Simultaneously, the primary electronic switches 120 shut off the electric current from the DC electric generator 124 going to batteries 132 and 134 while the secondary electronic switch 140 allow the electric current from batteries 132 and 134 to proceed towards the step-up transformers 150.

Once again, this internal recharging system is just a limited secondary method to charge a second set of batteries that are off-line. The primary method to charge all the batteries is via plugging into an external source of electricity. As well, even though in FIG. 2 illustrated the use of just one step-up transformer, the invention leaves room to have the electric current from the batteries run through multiple step-up transformers. Software can be programmed to up the voltage through more than one step-up transformer based on the difficulty of the driving conditions or the need to increase the speed (RPM's) for very fast high performance cars.

The value of this limited internal recharging system is to extend the range of the electric vehicle's battery system before requiring the driver to plug-in to an external source of electricity to recharge all the batteries; thus alleviating range anxiety. The uniqueness of this system is its

DC electric generator, which significantly increases the efficiency of the battery power in comparison to current hybrid and plug-in technology. Those models that employ an AC electric generator and then convert the current to DC in order to charge the batteries ended up wasting precious energy. The value of a DC electric generator makes this system much more efficient as well, it is 100% direct current compliant. This feature will make this limited self-charging system very marketable as fast DC charging stations become the dominant standard in the industry.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. An electric vehicle propulsion system comprising a first magnetic piston engine for providing propulsive force to the electric vehicle, a second magnetic piston engine for driving a DC electric generator, rechargeable batteries for providing electric power to the first and second magnetic piston engines, the rechargeable batteries being coupled to the DC electric generator to be at least partially recharged by the DC electric generator, wherein the first and second magnetic piston engines each comprise:
a. A magnetic piston having opposite first and second ends, a north and south magnetic polls formed on said first and second ends, the magnetic piston slidingly received in an elongated passage formed in a housing, the elongated passage having opposite first and second ends, the elongated housing configured to permit the magnetic piston to reciprocate between first and second positions corresponding to the first and second ends of the elongated passage, respectively;
b. The magnetic piston being oriented in the passage such that the first end of the magnetic piston is oriented towards the first end of the passage and the second end of the magnetic piston is oriented towards the second end of the passage;
c. A first electromagnet positioned in the housing immediately adjacent the first end of the passage, the electromagnet configured to generate a north magnetic pole oriented towards the first end of the passage when the first electromagnet is activated;
d. A second electromagnet positioned in the housing immediately adjacent the second end of the passage, the electromagnet configured to generate a south magnetic pole oriented towards the second end of the passage when the second electromagnet is activated:
e. An electric current source for providing an electric current sufficient to activate the first and second electromagnets, and
f. First and second switches coupled between the electric current source and the first and second electromagnets, respectively, the first and second switches being mounted to the housing adjacent the first and second ends of the passage such that the first and second switches contact the magnetic piston when the magnetic piston is in its first and second position, respectively, each of the first and second switches configured to close only upon contact with the magnetic piston, the first and second switches immediately opening when the magnetic piston is no longer in contact.

2. The electric vehicle propulsion system defined in claim 1 wherein the magnetic piston comprises a flat circular member made of a non-magnetic material sandwiched between first and second permanent magnets.

3. The electric vehicle propulsion system defined in claim 2 wherein the first permanent magnet comprises a cylindrical magnet coaxially aligned with and mounted on a first side of the flat circular member, and wherein the second permanent magnet comprises a torus shaped magnet coaxially aligned with and mounted on a second side of the flat circular member, a piston rod projected from the second side of the flat circular member through the torus shaped magnet, the first and second permanent magnets each having a diameter less than a diameter of the flat circular member.

4. The electric vehicle propulsion system defined in claim 3 wherein a first annular pad is formed on the first end of the passage and a second annular pad is formed on the second end of the passage, the first and second annular pads each having an internal diameter, the internal diameter of the first annular pad dimensioned to receive the first permanent magnet and the internal diameter of the second annular pad dimensioned to receive the second permanent magnet, the first and second annular pads and the first and second permanent magnets all being coaxially aligned.

5. An electric vehicle propulsion system comprising a first magnetic piston engine for providing propulsive force to the electric vehicle, a second magnetic piston engine for driving a DC electric generator, rechargeable batteries for providing electric power to the first and second magnetic piston engines, the rechargeable batteries being coupled to the DC electric generator to be at least partially recharged by the DC electric generator, wherein the first and second magnetic piston engines each comprise:
a. at least one magnetic piston having opposite north and south polls formed on opposite ends, the magnetic piston slidingly received in an elongated passage formed in a housing, the elongated passage having opposite first and second ends, the elongated housing configured to permit the magnetic piston to reciprocate between first and second positions corresponding to the first and second ends of the elongated passage, respectively;
b. A first electromagnet positioned in the housing immediately adjacent the first end of the passage, the first electromagnet configured to generate a north magnetic pole oriented towards the first end of the passage when the first electromagnet is activated;
c. A second electromagnet positioned in the housing immediately adjacent the second end of the passage, the second electromagnet configured to generate a south magnetic pole oriented towards the second end of the passage when the second electromagnet is activated:
d. An electric current source for providing an electric current sufficient to activate the first and second electromagnets;
e. First and second switches coupled between the electric current source and the first and second electromagnets, respectively, the first and second switches being mounted to the housing adjacent the first and second ends of the passage such that the first and second switches contact the magnetic piston when the magnetic piston is in its first and second position, respectively, each of the first and second switches configured to close only upon contact with the magnetic piston, the first and second switches immediately opening when the magnetic piston is no longer in contact.

6. The electric vehicle propulsion system defined in claim 5 wherein the first magnetic piston engine comprises a first plurality of identical magnetic pistons and wherein the second magnetic piston engine comprises a second plurality of identical magnetic pistons.

7. The electric vehicle propulsion system defined in claim 6 wherein the first magnetic piston engine has more magnetic pistons than the second magnetic piston engine.

8. The electric vehicle propulsion system defined in claim 7 further comprising four rechargeable electric batteries and a battery controller comprising a plurality of switches, the battery controller configured such that while two of the rechargeable electric batteries are drained to drive the first and second magnetic piston engines another two rechargeable electric batteries are being recharged by the DC electric generator, the battery controller being further configured to cyclically alternate between recharging and draining the rechargeable electric batteries.
